(19) United States
(12) Patent Application Publication
(10) Pub. No.: US 2012/0303727 A1
(43) Pub. Date: Nov. 29, 2012

(54) Method and System for Anonymously Initiating Social Exchange

(76) Inventor: William J. Spat, Aiyansh (CA)

(21) Appl. No.: 13/478,063

(22) Filed: May 22, 2012

Related U.S. Application Data
(60) Provisional application No. 61/488,796, filed on May 23, 2011.

(51) Int. Cl. G06F 15/16

(52) U.S. Cl. 709/206

(57) ABSTRACT

One embodiment for anonymously initiating social networking provides for a message (30) to be anonymously published by a user. Other parties can respond to the message and initiate a chat session (60) if the initial message is of interest. By means of the chat session, further particulars can be exchanged if users so desire. Other embodiments are described and shown.

### CROSS-REFERENCE TO RELATED APPLICATIONS

This application claims benefit of provisional patent application No. 61/488,796 filed 23 May 2011 by the present inventor.

### FEDERALLY SPONSORED RESEARCH

Not Applicable

### SEQUENCE LISTING OR PROGRAM

Not Applicable

### BACKGROUND

1. Field of Invention

This invention relates generally to facilitating social networking. More particularly, this invention relates to a method and system for allowing people to initiate social exchange while preserving anonymity.

2. Prior Art

Anonymous social exchange between parties such as people seeking romantic encounters is often facilitated by means of short messages in newspapers and other media. An account for the person seeking the romantic encounter is established, and the media keeps the identity of person seeking the romantic encounter secret from the public to whom their message is anonymously published. While only revealing certain things about themselves in their messages, parties seeking romantic encounters generally specify a kind of person that they wish to meet. For example, men may post messages under a classification such as ‘Men seeking Women,’ while women might post messages under a classification such as ‘Women seeking Men.’ Further qualities desired by the party posting the message may be specified in the body of the message or by means of further categories or interests. So for example, a woman seeking a woman might specify in her message that the woman responding must enjoy fine dining. It is expected that others who may also be seeking romantic encounters will search the messages posted in relevant categories or will search by means of relevant interests and respond to appropriate messages through the newspaper or other media. In this situation, the newspaper or other media can act as a means of publishing, receiving, or transmitting messages. The newspaper or other media also acts as a means of assuring anonymity on the part of seekers and sometimes on the part of respondents: identities may be revealed when parties are comfortable with sharing further details.

Newspapers commonly publish daily, weekly, or fortnightly so that the time between a wish to initiate social exchange being expressed in a short printed anonymous message and the opportunity for that wish to be fulfilled can be excessively long. And because of the size of newspaper print runs, a wish for social exchange may be expressed to a larger community that is wanted or needed, or for a longer period than is desired, resulting in wasted effort and misdirected intentions.

Furthermore, wishes for social exchange published in newspapers or by means of other media generally appeal to identities or proclivities which show a measure of consistency, rather than wishes that might change on a whim. For example, in U.S. Pat. No. 8,108,414 (2007) to Stackpole, personal and preference profiles are created using the client application. Connections are then made between users on the basis of characteristics set out in the profiles. There is no provision for social connections to be made between users on the basis of spontaneous or ephemeral expression.

Similarly U.S. Pat. No. 8,060,389 (2011) to Johnson establishes connections between users using service preferences first specified, rather than on information that may subsequently be shared by users interacting spontaneously.

Other systems and methods such as U.S. Pat. No. 7,620,902 (2005) to Manion et al. rely on characteristics of a pre-existing social network to provide access to other users, rather than on information that may subsequently be shared by users interacting spontaneously.

Still other systems and methods such as U.S. Pat. No. 7,720,037 (2006) to Bill appeal to precedent interest metrics to establish social connections.

The present invention may facilitate social networking by allowing users to anonymously publish faster to a more immediate public.

The Invention's purpose and practical use is to facilitate social networking and other exchanges. One embodiment could assist in facilitating romantic encounters. Another might facilitate meetings between persons sharing common inclinations such as the desire to go running together. Another could aid local commerce in goods and services. Many such uses are possible.

Still further objects, advantages, and applications may become apparent from a study of the following description and the accompanying drawings.

### SUMMARY

The invention, method and system for anonymously initiating social networking and other forms of social exchange, includes a method for allowing users to anonymously publish information by means of location-enabled data processing systems.

### DRAWINGS—FIGURES

FIG. 1 shows a user input screen on a location-enabled data processing system.

FIG. 2 shows a user input screen on a location-enabled data processing system on which a first user has entered an initial text message.

FIG. 3 shows a screen on a location-enabled data processing system where a user's message is shown on a map by means of a map marker in proximity to another marker showing a first user's location.

FIG. 4 shows a screen on a location-enabled data processing system where an attempt has been made to initiate social contact with a user who published a message “Hello, how's your day?”

FIG. 5 shows a screen on a location-enabled data processing system where users have had a social exchange and arranged to go running together.

FIG. 6 shows a general flowchart which outlines the process by which social exchange may be anonymously initiated using the present invention.

### DRAWINGS—REFERENCE NUMERALS

10 User input screen
20 Text input
30 Message
40 User marker
50 Advisory
60 Chat session
70 User inputs message
72 Message is anonymously published to other users
74 User responds to another user's message
76 No social network initiated
78 User responds to respondent
80 Social network initiated
82 Reciprocal social exchange

### DETAILED DESCRIPTION

### Preferred Embodiment

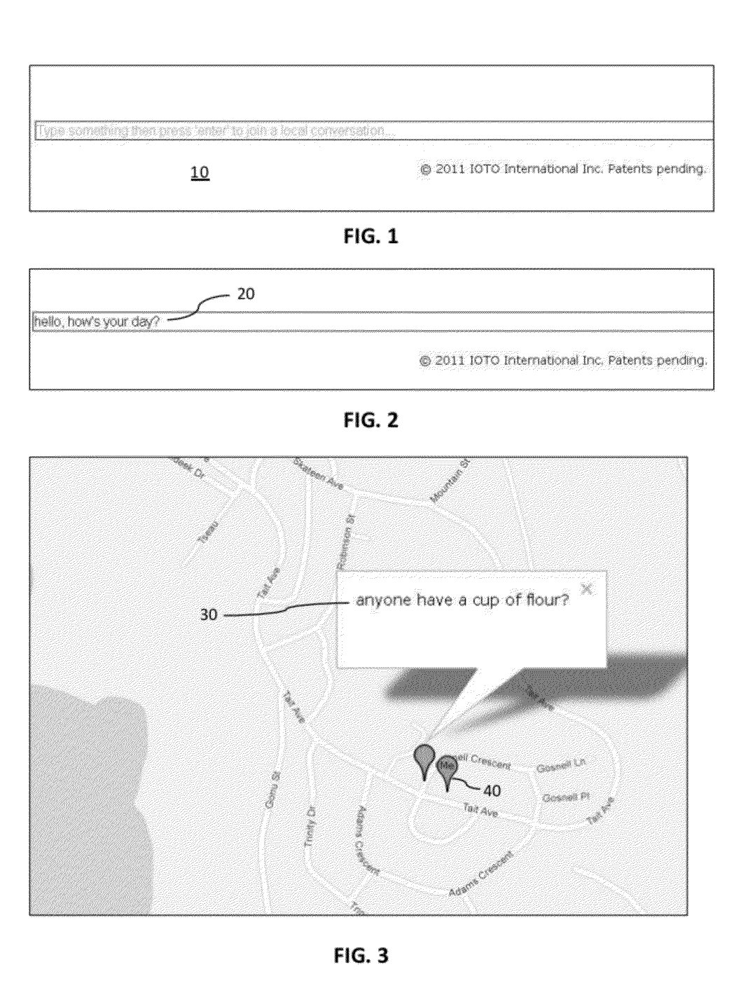

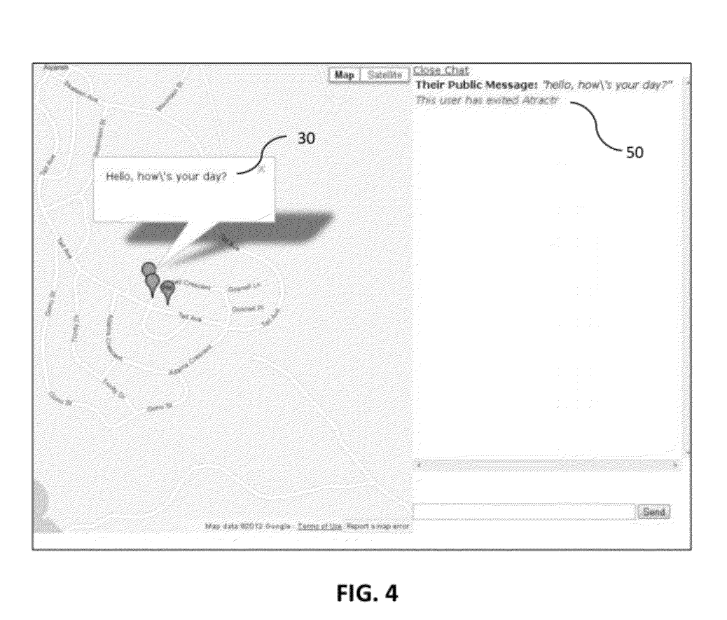

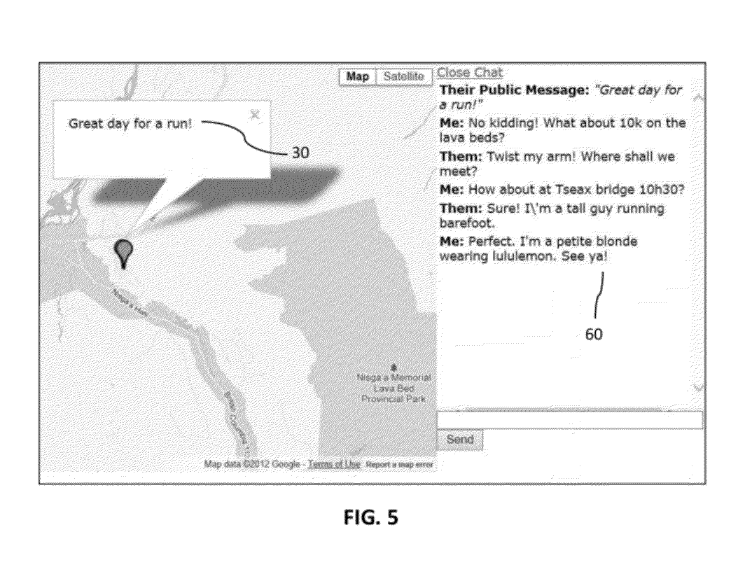

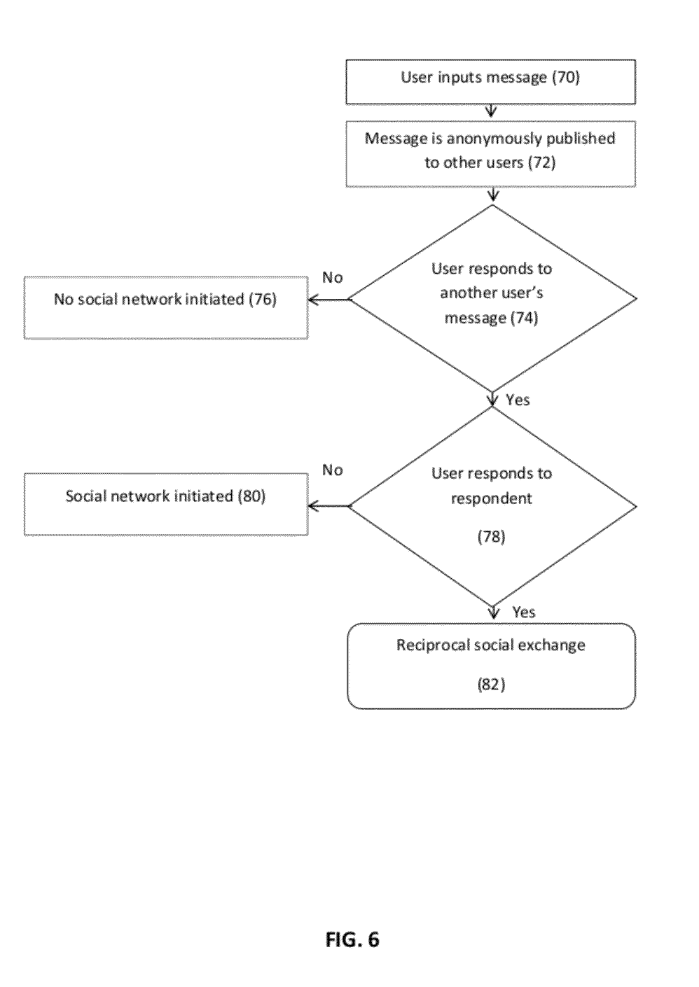

One embodiment of the method and system is illustrated in FIGS. 1, 2, 3, 4, 5, 6.

Using input screen 10 of a data processing system capable of geolocation, a user enters text 20. Text 20 is published to other proximate users who have themselves used the present method and system to publish other such messages 30. Users may respond to a message by clicking on that message to initiate anonymous chat session 60. Users attempting to initiate chat session 60 in response to a message that has been posted some time before may receive an advisory 50 that a user who published a message has exited the system. Or, if a message is not stale, and others are willing to respond, chat session 60 may be initiated with a user who published message 30. Users may exchange any manner of information during chat session 60. Or users my not respond at all if they do not so wish.

### Alternative Embodiments

### FIGS. 1, 2, 3, 4, 5, 6

There are various possibilities with regard to the kind of information that is posted by the present method and system. Text 20 is illustrated, but the present method and system could be adapted for images, sounds, and any other kinds of message or indicium that users may wish to use as a basis for social exchange.

Furthermore, spatial proximity may be used as a limiting factor in the presentation of message 30, but other criteria, such as time or similarities in contents of messages could be used as well. So for example, users posting text 20 containing a string “running” might be shown other messages which contain similar strings, regardless of proximity. Many variations are possible, including no limiting factors at all in the presentation of messages or indicia.

### DETAILED DESCRIPTION—FIGS. 1

### Preferred Embodiment

The method and system according to the invention provides a means whereby the user of a data processing system, capable of operating client software, such as a cellular phone, smart phone, PDA, iPod, iPad, tablet, laptop or desktop computer, can anonymously initiate social networking. Social networking is defined in this document as an exchange in which two or more people participate. An example of social networking is a two-sided conversation. Other examples of social networking could include commerce in goods and services.

The following discussion provides a brief and general description of a suitable computing environment in which the server, service provider data processing system, and data processing system included in various embodiments of the system may be implemented. Although not required, embodiments will be described in the general context of data processing system-executable instructions, such as program applications, modules, objects or macros being executed by a data processing system. Those skilled in the relevant art will appreciate that the invention can be practiced with other computing system configurations, including data processing systems, multiprocessor systems, microprocessor-based or programmable consumer electronics, personal data processing systems (“PCs”), network PCs, mini-data processing systems, mainframe data processing systems, and the like. The embodiments can be practiced in distributed computing environments where tasks or modules are performed by remote processing devices, which are linked through a communications network. In a distributed computing environment, program modules may be located in both local and remote memory storage devices.

As used herein, the terms “data processing system” and “server” are both computing systems as described in the following. A computing system may be used as a server, and includes one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal data processing systems, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during start-up.

A computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated data processing system-readable media, provide non-volatile storage of data processing system readable instructions, data structures, program modules and other data for the computing system. Although computing systems may employ hard disks, optical disks and/or magnetic disks, those skilled in the relevant art will appreciate that other types of non-volatile data processing system-readable media that can store data accessible by a data processing system may be employed, such a magnetic cassettes, memory sticks, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in an embodiment may be markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft.

The operating system and various applications/modules and/or data may be stored on the hard disk of the hard disk drive, the optical disk of the optical disk drive and/or the magnetic disk of the magnetic disk drive.

A computing system can operate in a networked environment using logical connections to one or more other computing systems and/or one or more database systems, such as one or more remote data processing systems or networks. A computing system may be logically connected to one or more client computing systems and/or database systems under any known method of permitting data processing systems to communicate, for example through a network such as a local area network (“LAN”) and/or a wide area network (“WAN”) including, for example, the Internet. Such networking environments are well known including wired and wireless enterprise-wide data processing system networks, intranets, extranets, and the Internet. Other embodiments include other types of communication networks such as telecommunications networks, cellular networks, paging networks, and other communication networks. The information sent or received via the communications channel may, or may not be encrypted. When used in a LAN networking environment, a computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked data processing systems. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between data processing systems, and other links may be used, including wireless links.

While in many instances a computing system will operate automatically, where an end user application interface is provided, an operator can enter commands and information into the computing system through an end user application interface including input devices, such as a keyboard, and a pointing device, such as a mouse, or a human digit on a touch screen. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device may be coupled to the bus via a video interface, such as a video adapter (not shown). The computing system can include other output devices, such as speakers, printers, etc.

An embodiment consists of client code running on a location-enabled data processing system such as a smartphone or tablet. The client code is used by users to compose a short message. The message can be text, voice, image, or any other information. The message, together with the location of the user who composed it and their communication address, is sent by the data processing system to a server, which aggregates similar messages from other users of the client code.

Again using client code running on a location-enabled data processing system, users can see the messages of other users which may originate within a certain distance of their present location during a certain time. Exact origin locations of messages may be randomized within a radius to preserve anonymity, so that seekers may know only what is divulged in the short message, and that the message originated within a certain distance.

Using the client code, users may select a published message to correspond with the originator of the message while preserving their own anonymity, or while divulging only as much or as little further information as they wish to share. After a pre-set period, the anonymous connection established between correspondents running client code on their respective data processing systems may be automatically broken. Or the anonymous connection may be broken at any time by either person. Correspondence may occur by means of text, voice, image, or any other means. And correspondence may be one to one, one to many, or many to one.

Spatial proximity is used in the above example to filter messages which might appear to a user. But other criteria may also be used to filter messages as well as no criteria at all. So for example, a user might specify that they want to be presented only with messages in Spanish. Or to be presented only messages which contain the word ‘love’ posted in the last sixty minutes. Or to be presented with messages in which the word ‘bagpipes’ has been supressed. Or a user may be presented with all messages with any content at all. Many filtering criteria are possible.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a data processing system program product that comprises a data processing system program mechanism embedded in a data processing system readable storage medium. For instance, the data processing system program product could contain program modules. These program modules may be stored on CD-ROM, DVD, magnetic disk storage product, flash media or any other data processing system readable data or program storage product. The software modules in the data processing system program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via application-specific integrated circuits. However, those skilled in the art will recognize that the embodiments disclosed herein, in whole or in part, can be equivalently implemented in standard integrated circuits, as one or more data processing system programs running on one or more data processing systems (e.g., as one or more programs running on one or more data processing systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and data processing system memory; and transmission type media such as digital and analog communication links using TDM or IP based communication links (e.g., packet links).

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventor contemplates the various aspects of the invention in any available claim form. For example, while only some aspects of the invention may currently be recited as being embodied in a data processing system-readable medium, other aspects may likewise be so embodied.

I claim:

1. A method of anonymously initiating social exchange between data processing system users comprising:
publishing messages to other said data processing system users; and
responding to a said published message;
wherein said data processing system users publish to other said data processing system users and receive responses from other said data processing systems users by means of an ephemeral link which is established between said users only on the basis of user's responses to said published messages.

2. The method of claim 1 wherein when said data processing system users may publish to or receive messages from within a certain spatial distance.

3. The method of claim 1 wherein said data processing system users may filter messages and responses based on some aspects of their content.

4. The method of claim 1 wherein said data processing system users may concurrently initiate multiple social exchanges.

5. A method of anonymously initiating social networking between data processing system users comprising:
a said data processing system user publishing messages to other said data processing system users;
a said data processing system user responding to a said published message;
wherein said data processing system users publish to other said data processing system users and may receive responses from other said data processing system users without first establishing an identity or account.

6. The method of claim 5 wherein when said data processing system users may publish to or receive messages from within a certain spatial distance or time.

7. The method of claim 5 wherein said data processing system users may filter messages and responses based on some aspects of their content.

8. The method of claim 5 wherein said data processing system users may concurrently initiate multiple social exchanges.

9. A system for anonymously initiating social networking, comprising:
a server, said server configured to receive messages from data processing systems;
said server publishing said messages;
said server receiving responses to said published messages;
said server sending said responses to said published messages to said data processing systems first originating said messages;
wherein said responses are exchanged between said data processing systems on an ad-hoc basis without user accounts or profiles first being registered on said server or said data processing systems.

10. The system of claim 9 wherein when said server is configured to publish to or receive messages from within a certain spatial distance or time.

11. The system of claim 9 wherein said server may filter messages and responses based on some aspects of their contents.

12. The system of claim 9 wherein said server may concurrently initiate multiple exchanges between said data processing systems.
